(19) United States
(12) Patent Application Publication
(10) Pub. No.: US 2013/0040478 A1
(43) Pub. Date: Feb. 14, 2013

(54) Card Connector

(71) Applicants: Ya-Hui Hsu, Taoyuan Country (TW); Te-Hung Yin, Taoyuan Country (TW)

(72) Inventors: Ya-Hui Hsu, Taoyuan Country (TW); Te-Hung Yin, Taoyuan Country (TW)

(73) Assignee: PROCONN TECHNOLOGY CO., LTD., Taoyuan Country (TW)

(21) Appl. No.: 13/205,783

(22) Filed: Aug. 9, 2011

(51) Int. Cl. H01R 13/62

(52) U.S. Cl. 439/159

(57) ABSTRACT

A card connector for receiving a card includes an insulating housing having a base board and an extending portion protruded rearward from one end of a rear of the base board. One side of the base board defines a sliding recess of which a bottom wall defines a guiding slot extending along an insertion direction of the card. The sliding recess is further spread rearward into the extending portion. An ejecting device for ejecting the card out of the card connector includes a slider slidably disposed in the sliding recess. A guiding portion is protruded on a bottom of the slider and received in the guiding slot for guiding the movement of the slider. A cover has a base plate covered on the base board and an extending plate extended rearward from one end of a rear of the base plate to be covered on the extending portion.

### BACKGROUND OF THE INVENTION

1. Field of the Invention

The present invention generally relates to an electrical connector, and more particularly to a card connector for receiving a card therein.

2. The Related Art

Traditionally, a card connector adapted for receiving a card includes an insulating housing, a plurality of terminals disposed in the insulating housing, an ejecting device movably disposed in one side of the insulating housing for ejecting the card out of the card connector, and a cover coupled on the insulating housing. The ejecting device includes a slider, a spring and a connecting bar. The insulating housing is generally of a rectangular shape in accordance with the ejecting device and a slide distance of the slider. As a result, the card connector often has a large volume and cannot meet miniaturization demand of present products.

### SUMMARY OF THE INVENTION

An object of the present invention is to provide a card connector adapted for receiving an external card therein. The card connector includes an insulating housing having a base board which defines a receiving chamber penetrating through a top and a front thereof for receiving the card therein, and an extending portion protruded rearward from one end of a rear of the base board. One side of the receiving chamber defines a sliding recess of which a bottom wall defines a guiding slot extending along an insertion direction of the card. The sliding recess is further spread rearward into the extending portion. A plurality of terminals is disposed in the base board of the insulating housing and stretches into the receiving chamber for electrically contacting the card. An ejecting device used for ejecting the card out of the card connector includes a slider slidably disposed in the sliding recess, an elastic element elastically clipped between the slider and a rear wall of the sliding recess, and a connecting bar of which one end is fastened in a front of the base board and the other end is slidably located in the slider. A rear of one side of the slider protrudes towards the receiving chamber to form a pushing projection for ejecting the card out. A guiding portion is protruded on a bottom side of the slider and received in the guiding slot for guiding the movement of the slider. A cover coupled on the insulating housing has a base plate covered on the base board, and an extending plate extended rearward from one end of a rear edge of the base plate to be covered on the extending portion.

As described above, the extending portion of the insulating housing is designed to lengthen the sliding recess thereto so as to meet a demand of a slide distance of the slider, so that can accordingly shorten the base board to realize a small volume of the insulating housing so as to meet a miniaturization demand of the card connector.

### BRIEF DESCRIPTION OF THE DRAWINGS

The present invention will be apparent to those skilled in the art by reading the following description, with reference to the attached drawings, in which:

FIG. 1 is an assembled perspective view of a card connector according to an embodiment of the present invention;

FIG. 2 is an exploded perspective view of the card connector of FIG. 1;

FIG. 3 is a perspective view of a slider of the card connector of FIG. 2; and

FIG. 4 is an assembled perspective view of the card connector of FIG. 1 except a cover.

### DETAILED DESCRIPTION OF THE PREFERRED EMBODIMENT

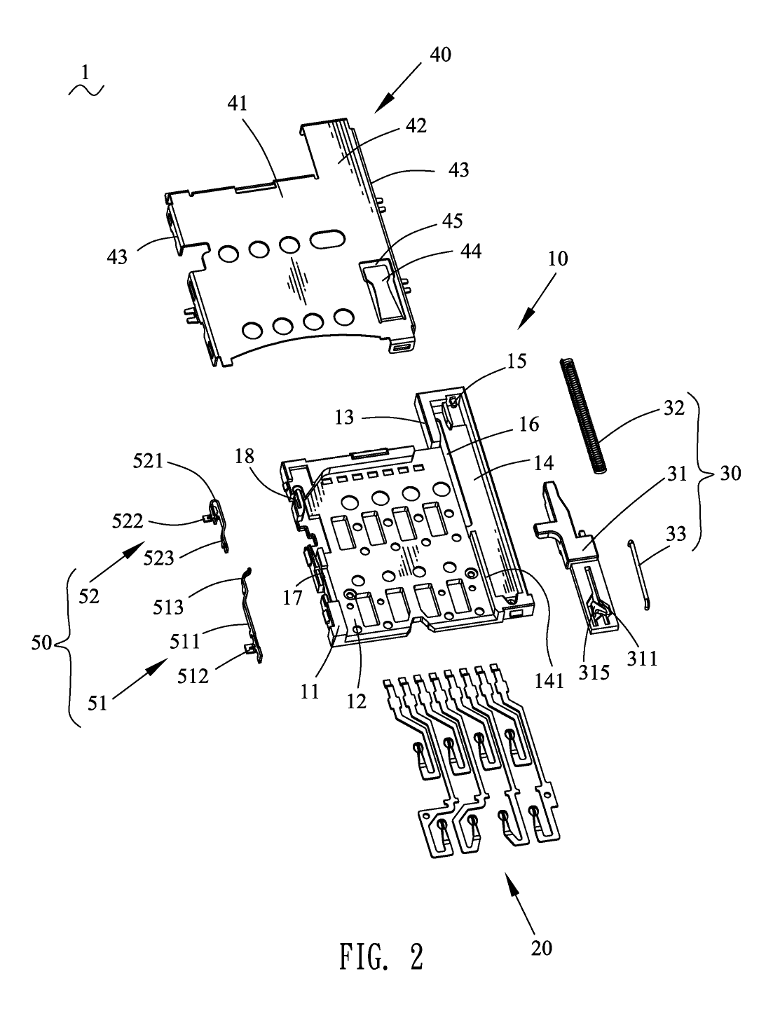

With reference to FIG. 2, a card connector 1 according to the present invention includes an insulating housing 10, a plurality of terminals 20, an ejecting device 30, a cover 40 and a switch terminal assembly 50.

In FIG. 2 and FIG. 4, the insulating housing 10 has a rectangular base board 11 which defines a rectangular receiving chamber 12 penetrating through a top and a front thereof for receiving a card (not shown) therein, and an extending portion 13 protruded rearward from one end of a rear of the base board 11. One side of the receiving chamber 12 is further concaved downward to form a sliding recess 14 extending along a front-to-rear direction and further spread rearward into the extending portion 13. A rear wall of the sliding recess 14 protrudes forward to form a retaining rod 15. A bottom wall of the sliding recess 14 defines a guiding slot 16 extending along the front-to-rear direction. A front of the bottom wall of the sliding recess 14 protrudes upward to form a positioning rib 141 extending along the front-to-rear direction and adjacent to the receiving chamber 12 and a front wall of the sliding recess 14. One side wall of the base board 11 far away from the sliding recess 14 defines a first fastening fillister 17 in a front thereof and a second fastening fillister 18 in a rear thereof, wherein a front end of the second fastening fillister 18 and a rear end of the first fastening fillister 17 are communicated with each other and further connected with the receiving chamber 12. The terminals 20 are molded in a bottom wall of the receiving chamber 12 of the insulating housing 10 at regular intervals and further stretch into the receiving chamber 12 for electrically contacting with the card.

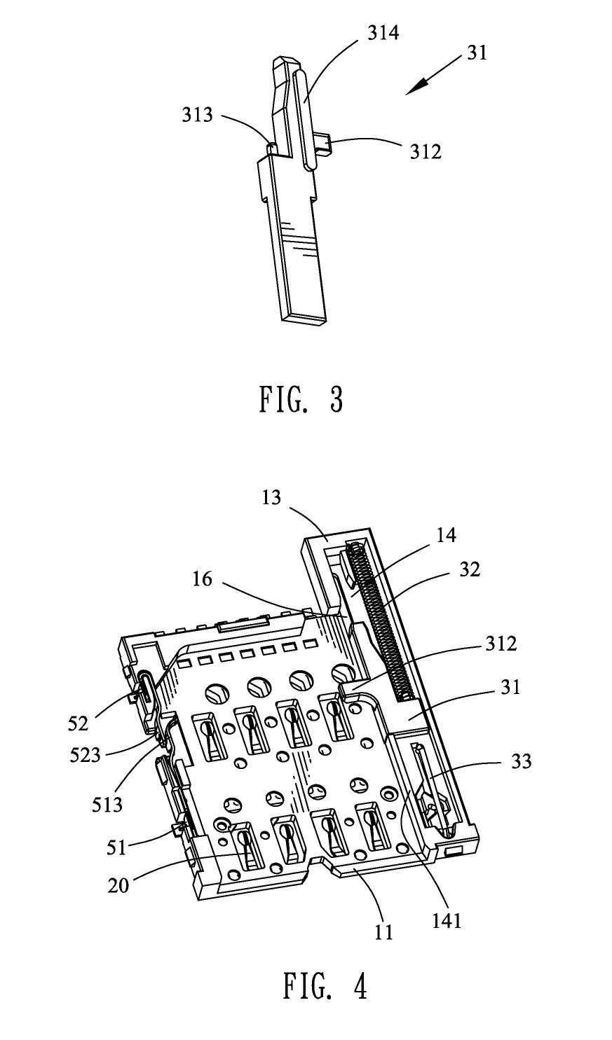

Referring to FIGS. 2-4, the ejecting device 30 includes a slider 31, an elastic element and a connecting bar 33. In this embodiment, the elastic element is a spring 32. The slider 31 defines a trace cavity 311 in a top thereof. A trace shoulder 315 is defined in the trace cavity 311 and located apart from a periphery inside of the trace cavity 311. A rear of one side of the slider 31 protrudes sideward to form a pushing projection 312. A rear end of the slider 31 protrudes rearward to form a positioning rod 313. A guiding portion 314 is protruded downward on a bottom side of the slider 31. The slider 31 is movably disposed in the sliding recess 14 of the insulating housing 10, with the pushing projection 312 stretching into the receiving chamber 12 for the convenience of the card pushing the slider 31 to slide rearward and the slider 31 pushing the card to move forward out of the receiving chamber 12, and the guiding portion 314 being slidably received in the guiding slot 16 for guiding the movement of the slider 31. One end of the spring 32 is worn around the retaining rod 15 of the insulating housing 10 and the other end thereof is worn around the positioning rod 313 of the slider 31 to make a front of the slider 31 positioned between the positioning rib 141 and a side wall of the sliding recess 14 far away from the receiving chamber 12. One end of the connecting bar 33 is fastened in a front of the base board 11, and the other end thereof is slidably located in the trace cavity 311 of the slider 31 for collaborating with the trace shoulder 315 to realize insertion and ejection of the card.

Referring to FIG. 2 and FIG. 4, the switch terminal assembly 50 includes a first switch terminal 51, and a second switch terminal 52. The first switch terminal 51 has a long first base strip 511 fastened in the first fastening fillister 17 of the insulating housing 10, a first soldering tail 512 bent sideward from a front of a bottom edge of the first base strip 511 to be projected under the insulating housing 10, and a curved contact arm 513 extending rearward from a rear end of the first base strip 511 to further stretch sideward into the receiving chamber 12. The second switch terminal 52 has a U-shaped second base strip 521 fastened in the second fastening fillister 18, a second soldering tail 522 bent sideward from a bottom edge of an outer arm of the second base strip 521 to be projected under the insulating housing 10, and a contact portion 523 curvedly extending forward from a front end of an inner arm of the second base strip 521 to be apart located at one side of the contact arm 513 opposite to the receiving chamber 12. In use, the contact arm 513 of the first switch terminal 51 is pressed sideward by the card to electrically contact with the contact portion 523 of the second switch terminal 52 so as to realize a switch function, when the card is fully inserted in the card connector 1.

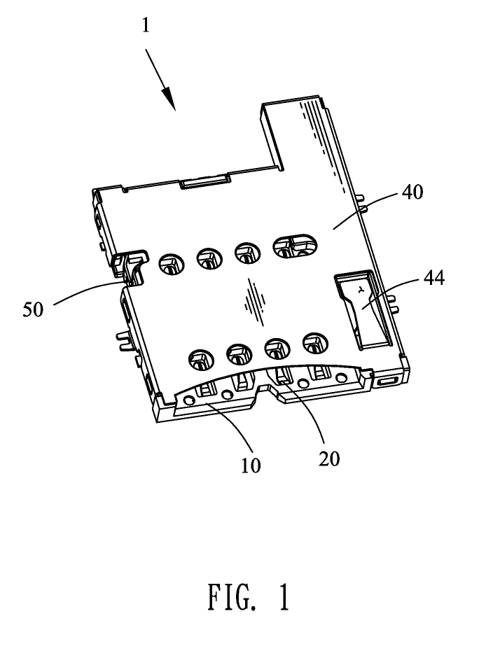

Referring to FIG. 1 and FIG. 2, the cover 40 is coupled on the insulating housing 10, and has a rectangular base plate 41 covered on the base board 11, an extending plate 42 extended rearward from one end of a rear edge of the base plate 41 to be covered on the extending portion 13, and two side plates 43 bent downward from both opposite side edges of the base plate 41, wherein one of the side plates 43 is further connected with an outer side edge of the extending plate 42. One side of a front of the base plate 41 defines an opening 45 above the ejecting device 30. A front edge of the opening 45 extends rearward and is inclined downward to form a restraining slice 44 resisting against the connecting bar 33 for restraining the connecting bar 33 to steadily slide in the trace cavity 311 of the slider 31.

Referring to FIG. 1 and FIG. 4, in the process of the card being inserted into and ejected out of the card connector 1, the front of the slider 31 is always positioned between the positioning rib 141 and the side wall of the sliding recess 14 far away from the receiving chamber 12 during the slider 31 slides rearward and forward, so that cooperates with the guidance of the guiding slot 16 and the guiding portion 314 to further ensure a straight-line motion of the slider 31.

As described above, the extending portion 13 of the insulating housing 10 is designed to lengthen the sliding recess 14 thereto so as to meet a demand of a slide distance of the slider 31, so that can accordingly shorten the base board 11 to realize a small volume of the insulating housing 10 so as to meet a miniaturization demand of the card connector 1.

What is claimed is:

1. A card connector adapted for receiving an external card therein, comprising:
an insulating housing having a base board which defines a receiving chamber penetrating through a top and a front thereof for receiving the card therein, and an extending portion protruded rearward from one end of a rear of the base board, one side of the receiving chamber defining a sliding recess of which a bottom wall defines a guiding slot extending along an insertion direction of the card, the sliding recess being further spread rearward into the extending portion;
a plurality of terminals disposed in the base board of the insulating housing and stretching into the receiving chamber for electrically contacting the card;
an ejecting device used for ejecting the card out of the card connector and including a slider slidably disposed in the sliding recess, an elastic element elastically clipped between the slider and a rear wall of the sliding recess, and a connecting bar of which one end is fastened in a front of the base board and the other end is slidably located in the slider, a rear of one side of the slider protruding towards the receiving chamber to form a pushing projection for ejecting the card out, a guiding portion being protruded on a bottom side of the slider and received in the guiding slot for guiding the movement of the slider; and
a cover coupled on the insulating housing, the cover having a base plate covered on the base board, and an extending plate extended rearward from one end of a rear edge of the base plate to be covered on the extending portion.

2. The card connector as claimed in claim 1, wherein a front of the bottom wall of the sliding recess protrudes upward to form a positioning rib extending along the insertion direction of the card and adjacent to the receiving chamber and a front wall of the sliding recess, the front of the slider is positioned between the positioning rib and a side wall of the sliding recess far away from the receiving chamber during the slider slides rearward and forward.

3. The card connector as claimed in claim 1, wherein the rear wall of the sliding recess protrudes forward to form a retaining rod, a rear end of the slider protrudes rearward to form a positioning rod, one end of the elastic element is worn around the retaining rod and the other end thereof is worn around the positioning rod.

4. The card connector as claimed in claim 1, wherein two opposite side edges of the base plate of the cover are bent downward to form two side plates of which one is further connected with an outer side edge of the extending plate, one side of a front of the base plate defines an opening above the ejecting device, a front edge of the opening extends rearward and is inclined downward to form a restraining slice resisting against the connecting bar for restraining the connecting bar to steadily slide in the slider.

5. The card connector as claimed in claim 1, further comprising a first switch terminal which has a first base strip fastened in a front of one side wall of the base board far away from the sliding recess and a contact arm extending rearward from a rear end of the first base strip to further stretch sideward into the receiving chamber, and a second switch terminal which has a U-shaped second base strip fastened in a rear of the one side wall of the base board and a contact portion curvedly extending forward from one front end of the second base strip to be apart located at one side of the contact arm opposite to the receiving chamber, the contact arm electrically contacts with the contact portion under the pressure of the card.

6. The card connector as claimed in claim 5, wherein a bottom edge of the first base strip is bent sideward to form a first soldering tail projected under the insulating housing, and a bottom edge of the second base strip is bent sideward to form a second soldering tail projected under the insulating housing.
